(19) United States
(12) Patent Application Publication
(10) Pub. No.: US 2018/0137955 A1
(43) Pub. Date: May 17, 2018

(54) MANUFACTURING METHOD AND MANUFACTURING APPARATUS FOR WIRE HARNESS OUTER MEMBER

(71) Applicants: AutoNetworks Technologies, Ltd., Yokkaichi (JP); Sumitomo Wiring Systems, Ltd., Yokkaichi (JP); SUMITOMO ELECTRIC INDUSTRIES, LTD., Osaka (JP)

(72) Inventor: Atsushi MURATA, Yokkaichi (JP)

(21) Appl. No.: 15/793,385

(22) Filed: Oct. 25, 2017

(30) Foreign Application Priority Data
Nov. 16, 2016 (JP) 2016-223148

(51) Int. Cl. H01B 13/012; H01B 7/00

(52) U.S. Cl. CPC H01B 13/01281; H01B 7/0045

(57) ABSTRACT

A method of manufacturing a wire harness outer member includes: (a) transporting the base material in an extension direction; (b) sequentially forming perforations in the transported base material along the extension direction by rotating perforating blades around an axis following a direction intersecting with the extension direction while pinching the base material between the perforating blades and an anvil provided opposite the perforating blades, more of the perforating blades being provided on the one side of the base material than on the other side; and (c) correcting a difference in tensile force between the one side and the other side of the base material by pressing a tensile force correction member against the other side of the base material.

### CROSS REFERENCE TO RELATED APPLICATIONS

This application claims the priority of Japanese patent application JP2016-223148 filed on Nov. 16, 2016, the entire contents of which are incorporated herein.

### TECHNICAL FIELD

This invention relates to a technique for manufacturing a wire harness outer member.

### BACKGROUND ART

JP 2014-17985A discloses a method of wrapping wires with a protective sheet, in which double-sided adhesive tape is provided on both edges of the protective sheet that follow an extension direction of the wires, with one edge affixed to a wire side and serving as a wrap starting part, and the other edge affixed to an outer surface of the protective sheet already wrapped around the wires and serving as a wrap ending part.

However, according to the technique disclosed in JP 2014-17985A, restorative force that brings the protective sheet back to its original state causes the protective sheet to deform and increase in diameter, leading to a risk that the protective sheet cannot be kept wrapped to a small diameter. Additionally, if the restorative force that brings the protective sheet back to its original state is stronger than the adhesive force of the double-sided adhesive tape, there is a risk that the double-sided adhesive tape at the wrap ending part will peel away.

Accordingly, the applicant has proposed an outer member capable of suppressing restorative force by providing a perforation in a sheet-form base material that follows the extension direction of wires when the base material is wrapped around the wires. An outer member in which different numbers of perforations are provided to the left and right of the center of the base material has also been proposed. Such an outer member is thought to be capable of more effectively suppressing restorative force by, for example, wrapping the wires using the side of the base material with the greater number of perforations as the wrapping start side.

Here, when such outer members in which perforations are provided are to be manufactured in a continuous manner, it is conceivable to employ a method that provides perforations following the extension direction in parts of the base material while feeding the base material in the extension direction.

JP 2014-17985A is an example of the background art.

However, when manufacturing an outer member in which different numbers of perforations are provided to the left and right of the center of the base material, there will be different numbers of perforating blades on the left and right sides of the base material. As such, the force at which the base material will not match between the left and right sides of the base material. This unbalances the transport of the base material, leading to a risk that the base material will deviate from the transport path.

Accordingly, an object of the present application is to provide a technique that, when manufacturing an outer member in which different numbers of perforations are provided on left and right sides of a base material, can balance the force at which the base material is fed between the left and right sides of the base material to the greatest extent possible.

### SUMMARY

To solve the above-described problems, a method of manufacturing a wire harness outer member according to a first aspect is a method of manufacturing a wire harness outer member in which many perforations are provided on one side of a base material relative to the center of the base material than on the other side, the method including: (a) transporting the base material in an extension direction; (b) sequentially forming perforations in the transported base material along the extension direction by rotating perforating blades around an axis following a direction intersecting with the extension direction while pinching the base material between the perforating blades and an anvil provided opposite the perforating blades, more of the perforating blades being provided on the one side than on the other side; and (c) correcting a difference in tensile force between the one side and the other side of the base material by pressing a tensile force correction member against the other side of the base material.

A method of manufacturing a wire harness outer member according to a second aspect is the method of manufacturing a wire harness outer member according to the first aspect, wherein the tensile force correction member is provided alongside the perforating blades on the other side, and pinches the base material against the anvil.

A method of manufacturing a wire harness outer member according to a third aspect is the method of manufacturing a wire harness outer member according to the second aspect, wherein the tensile force correction member includes a roller that rotates around an axis parallel to a rotation axis of the perforating blades.

A method of manufacturing a wire harness outer member according to a fourth aspect is the method of manufacturing a wire harness outer member according to the third aspect, wherein a non-planar part is formed in an outer circumference of the roller.

A method of manufacturing a wire harness outer member according to a fifth aspect is the method of manufacturing a wire harness outer member according to the fourth aspect, wherein the non-planar part includes an axial direction non-planar part formed along an axial direction of the roller.

A method of manufacturing a wire harness outer member according to a sixth aspect is the method of manufacturing a wire harness outer member according to the fifth aspect, wherein the roller includes a pseudo-blade roller formed so that a pitch of the axial direction non-planar part is the same as intervals between the perforating blades arranged on the one side.

A method of manufacturing a wire harness outer member according to a seventh aspect is the method of manufacturing a wire harness outer member according to any one of the first to sixth aspects, wherein a depth of the perforating blades relative to the base material is adjusted by pressing a collar member formed having a smaller diameter than the perforating blades and provided adjacent to the perforating blades against the base material.

A manufacturing apparatus for a wire harness outer member according to an eighth aspect is a manufacturing apparatus for a wire harness outer member in which many perforations are provided on one side of a base material relative to the center of the base material than on the other side, the apparatus including: a transport section that transports the base material in an extension direction; a perforation processing section, including perforating blades capable of rotating around an axis following a direction intersecting with the extension direction, more of the perforating blades being provided on the one side than on the other side, and an anvil, provided opposite the perforating blades, that pinches the base material against the perforating blades, the perforation processing section sequentially forming perforations in the transported base material along the extension direction; and a tensile force correction member, provided capable of pressing on the other side, that corrects a difference in tensile force between the one side and the other side of the base material.

According to the first to seventh aspects, a difference in the tensile force on the left and right sides of the base material is corrected by pressing the tensile force correction member provided on the other side that has fewer perforating blades against the base material. Thus when manufacturing the outer member in which different numbers of perforations are provided on the left and right sides of the base material, the force at which the base material is transported can be balanced between the left and right sides of the base material to the greatest extent possible.

Particularly, according to the second aspect, the tensile force can be corrected at the position of the perforating blades with respect to the transport direction of the base material.

Particularly, according to the third aspect, the roller rotates in the same manner as the perforating blades, and thus it is more difficult for excess force to be applied than in the case where the roller does not rotate.

Particularly, according to the fourth aspect, it is easier to catch the base material than in the case where the non-planar part is not provided.

Particularly, according to the fifth aspect, it is easier to catch the base material than in the case where the non-planar part is not provided in the axial direction.

Particularly, according to the sixth aspect, the pseudo-blade roller catches the base material along a direction intersecting with the extension direction at the same intervals as the perforating blades, and thus it is more difficult for the base material to twist or the like.

Particularly, according to the seventh aspect, the depth of the perforating blades is adjusted by the collar member, and thus a situation in which the perforating blades bite into the anvil excessively can be suppressed.

According to the eighth aspect, a difference in the tensile force on the left and right sides of the base material is corrected by the tensile force correction member provided on the other side that has fewer perforating blades. Thus when manufacturing the outer member in which different numbers of perforations are provided on the left and right sides of the base material, the force at which the base material is transported can be balanced between the left and right sides of the base material to the greatest extent possible.

### BRIEF DESCRIPTION OF THE DRAWINGS

FIG. 1 is a plan view of a wire harness outer member;

FIG. 2 is a front view of a state in which the wire harness outer member is attached to wires;

FIG. 3 is a schematic side view of a manufacturing apparatus for the wire harness outer member according to an embodiment;

FIG. 4 is a schematic plan view of a manufacturing apparatus for the wire harness outer member according to an embodiment;

FIG. 5 is a schematic plan view of a perforation processing section;

FIG. 6 is a schematic side view of the perforation processing section;

FIG. 7 is a schematic front view of the perforation processing section;

FIG. 8 is a descriptive diagram illustrating a state where perforation blades make contact with a base material;

FIG. 9 is a perspective view of a tensile force correction member;

FIG. 10 is a perspective view of a variation on the tensile force correction member;

FIG. 11 is a plan view of the variation on the tensile force correction member;

FIG. 12 is a plan view of another variation on the tensile force correction member; and

FIG. 13 is a plan view of yet another variation on the tensile force correction member.

### EMBODIMENTS OF THE INVENTION

### Embodiment

A method and apparatus for manufacturing a wire harness outer member according to an embodiment will be described hereinafter.

The method and apparatus for manufacturing the wire harness outer member are a method and apparatus for manufacturing a wire harness outer member 10 in which more perforations 14 are provided on one side of a base material 12 relative to the center thereof than on the other side.

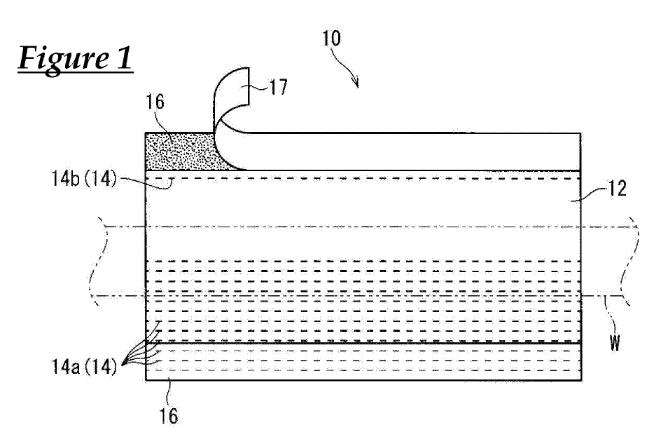

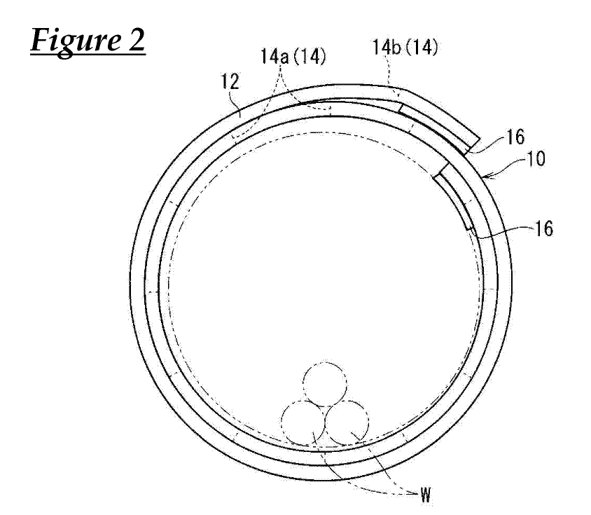

The wire harness outer member 10 to be manufactured will be described with reference to FIGS. 1 and 2. FIG. 1 is a plan view of the wire harness outer member 10. FIG. 2 is a front view of a state in which the wire harness outer member 10 is attached to wires W.

The wire harness outer member 10 includes a base material 12 formed in a sheet shape, and perforations 14 provided in the base material 12.

The base material 12 is formed such that the base material 12 can be wrapped around the wires W. Here, it is assumed that a restorative force works in the base material 12 in a direction that unwraps the base material 12 from the state in which the wires W are wrapped. A resin such as polyvinyl chloride (PVC) or polypropylene (PP) formed in a uniform manner can be considered as an example of the material used for the base material 12. It is also conceivable to employ a nonwoven fabric such as spunbond nonwoven fabric. The base material 12 is formed such that the base material 12 can be wrapped around the wires W twice. However, the base material 12 may be wrapped around the wires W more or less than twice.

The perforations 14 are collections of pluralities of indentations 15, having small dimensions along an extension direction, that are formed at intervals in the extension direction. In other words, the small indentations 15 are formed intermittently in the extension direction to form the perforations 14. The indentations 15 may be holes having a width dimension (a dimension along a direction orthogonal to the extension direction), or may be cuts having no width dimension. In the case where the indentations 15 are holes, the shapes of the holes are not particularly limited. However, the holes are preferably long holes that are longer in the extension direction, formed having a longitudinal shape, an oval shape, or the like. Note that the perforations 14 may be slanted slightly relative to the extension direction of the wires W.

The part of the base material 12 where the perforations 14 are formed is less rigid than other parts. This reduces the restorative force when the base material 12 is wrapped. It is thus easy to maintain the wrapped state. In particular, the parts of the base material 12 where the perforations 14 are formed can bend into a curved shape. When the part of the base material 12 where the perforations 14 are formed bends into a curved shape, the part of the base material 12 aside from where the perforations 14 are formed can have a low curvature radius, which reduces the restorative force thereof. Furthermore, depending on the material constituting the base material 12, the part where the perforations 14 are formed may retain the curved shape or a similar shape thereto upon being bent into the curved shape. This too is thought to weaken the restorative force.

Here, the perforations 14 are provided in both a wrap starting part and a wrap ending part.

Perforations 14a in the wrap starting part are provided in a region located on what is an inner circumferential side when the base material 12 is wrapped twice around the wires W. Accordingly, the restorative force is lower in the part wrapped around the inner circumferential side, where the diameter is smaller, than the part wrapped around an outer circumferential side, which reduces the force by which the diameter attempts to increase. As a result, the inner circumferential side part can be kept in a state where the diameter is small.

Perforations 14b in the wrap ending part are formed in a boundary region with a part bonded using double-sided adhesive tape 16 or the like. The restorative force at the boundary region with the part of the base material 12 therefore decreases, and a force that attempts to debond the bonded part is weakened. As a result, it becomes difficult for the bonded part to debond, and makes it easier to maintain the wrapped state of the outer member.

In the example illustrated in FIG. 2, there are 12 perforations 14a formed at equal intervals in the circumferential direction, but the number and positions of the perforations 14a are not limited thereto. Additionally, although one line of perforations 14b is formed, the number and position of the perforations 14b is not limited thereto. However, the number of the perforations 14a and the number of the perforations 14b differ here. The number of the perforations 14a is made greater than the number of the perforations 14b.

Additionally, here, the double-sided adhesive tape 16 is affixed along the outer edges of the base material 12 on both sides thereof. The descriptions assume that the double-sided adhesive tape 16 is cut into predetermined dimensions after the perforations 14 are formed in the long base material 12, and affixed as part of manufacturing the wire harness outer member 10. In this case, it is conceivable to provide backing paper 17 on the surface of the adhesive layer in the pre-wrapping base material 12, as illustrated in FIG. 1. However, the double-sided adhesive tape 16 may be affixed after being cut into predetermined dimensions, or may not be affixed.

Next, an apparatus for manufacturing the wire harness outer member 10, in which the left and right sides of the base material 12 have different numbers of perforations 14 as described above, will be described.

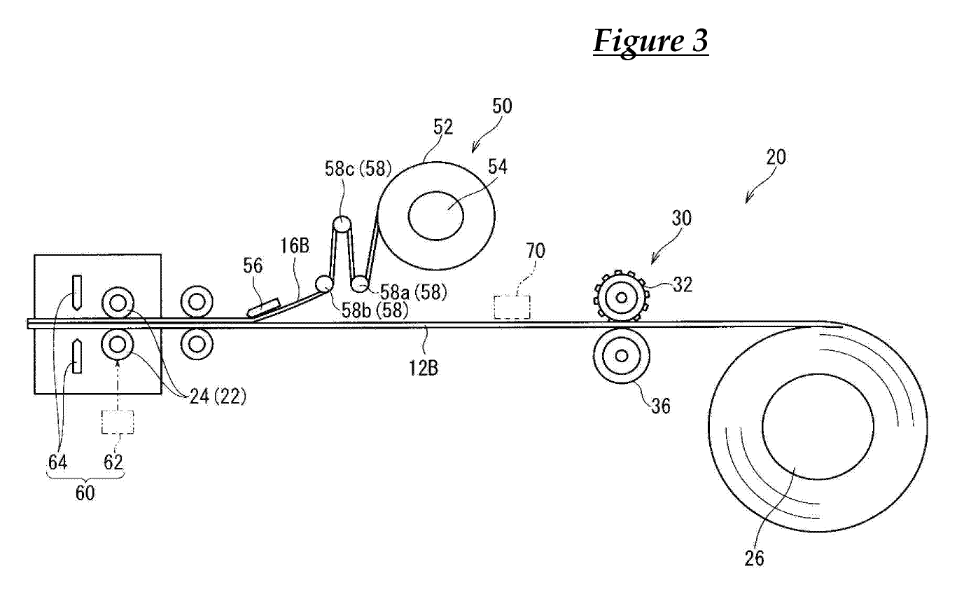

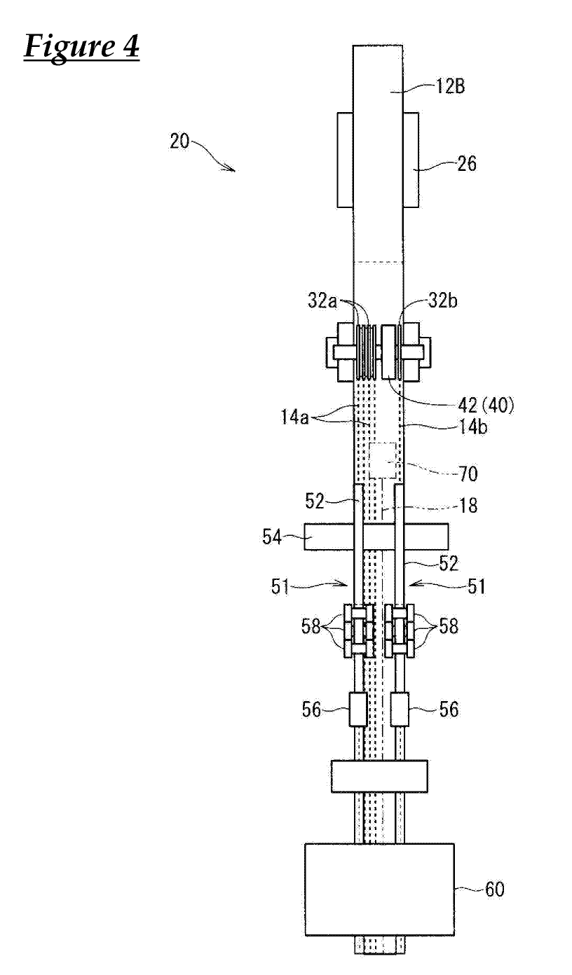

The overall configuration of a manufacturing apparatus 20 for a wire harness outer member according to an embodiment will be described with reference to FIGS. 3 and 4. FIG. 3 is a schematic side view of the manufacturing apparatus 20 for the wire harness outer member according to the embodiment. FIG. 4 is a schematic plan view of the manufacturing apparatus 20 for the wire harness outer member according to the embodiment.

The manufacturing apparatus 20 for the wire harness outer member includes a transport section 22, a perforation processing section 30, and a tensile force correction member 40. Here, the manufacturing apparatus 20 for the wire harness outer member 10 further includes a feed-out drum 26, a double-sided adhesive tape affixing section 50, and a length adjustment cutting section 60.

The feed-out drum 26, which holds a long base material 12B prior to the perforations 14 being formed therein in a wound-up state, is disposed furthest upstream in a transport direction. The transport section 22 transports the base material 12B from the feed-out drum 26 in the transport direction. As a result, the base material 12B is transported by the transport section 22 along the extension direction. The transport section 22 is constituted of, for example, a pair of driving rollers 24, and is provided downstream from the feed-out drum 26. The descriptions here assume that the pair of driving rollers 24 are incorporated into the length adjustment cutting section 60 on the downstream side.

The base material 12B fed out from the feed-out drum 26 is first transported to the perforation processing section 30. The perforations 14 are formed in the base material 12B transported to the perforation processing section 30 by perforating blades 32 of the perforation processing section 30. Here, the perforating blades 32 are rotating blades provided capable of rotating around an axis following a direction intersecting with the extension direction of the base material 12. The perforating blades 32 pinch the base material 12 against an anvil 36 disposed opposite the perforating blades 32, and form the perforations 14 while rotating against the base material 12B transported thereto. The perforating blades 32 are formed so that the parts thereof with the greatest diameters are not continuous in the circumferential direction, in order to form the perforations 14.

Here, different numbers of the perforations 14 are formed on the left and right sides of the base material 12B, as described above. To that end, different numbers of perforating blades 32 are provided on the left and right in the perforation processing section 30. When different numbers of the perforating blades 32 are provided on the left and right in this manner, the tensile force acting on the left and right sides of the base material 12B (tension acting on the base material 12B between the driving rollers 24 and the perforation processing section 30) will differ. Specifically, the tensile force changes depending on the material and thickness of the base material 12B, the shapes, materials, and numbers of the perforating blades 32, the shape and material of the anvil 36, the gap between the perforating blades 32 and the anvil 36, the driving force of the driving rollers 24, and so on. However, as a general rule, a greater tensile force acts on the side with the greater number of perforating blades 32 than the side with the lower number of perforating blades 32.

If the tensile force differs between the right and left of the base material 12B in this manner, the transport of the base material 12B will become unbalanced, and there is a risk that the base material 12B will deviate from the transport path. To prevent this from occurring, the tensile force correction member 40 corrects differences between the right and left tensile forces. The tensile force correction member 40 is provided on the side having the lower number of perforating blades 32. The tensile force correction member 40 is pressed against the base material 12B. As a result, the tensile force on the side of the base material 12B having the lower number of perforating blades 32 is increased, which corrects the difference in the tensile force between the right and left sides. Here, as the tensile force correction member 40, a roller 42 is provided alongside the perforating blades 32 on the side with the lower number of perforating blades 32.

The perforation processing section 30 and the tensile force correction member 40 will be described in detail later.

The base material 12B, in which the perforations 14 have been formed by the perforation processing section 30 and in which the difference in tensile force between the right and left sides has been corrected by the tensile force correction member 40, is then transported to the double-sided adhesive tape affixing section 50. Here, double-sided adhesive tape 16B is pulled out from a tape roll 52 that holds the double-sided adhesive tape 16B in a rolled-up state, and is affixed to the base material 12B. The double-sided adhesive tape 16B is affixed to both outer edges of the base material 12B. Accordingly, here, a double-sided adhesive tape affixing mechanism 51 is provided on both the right and left sides of the base material 12. Specifically, each double-sided adhesive tape affixing mechanism 51 includes the aforementioned tape roll 52, a roll support member 54, a tape press member 56, and a plurality of rollers 58.

The roll support member 54 supports the tape roll 52 in a rotatable manner. The tape press member 56 presses the double-sided adhesive tape 16B pulled out from the tape roll 52 toward the base material 12B while the double-sided adhesive tape 16B is close to the top of the base material 12B so as to firmly fix the double-sided adhesive tape 16B to the base material 12B. The plurality of rollers 58 are disposed between the tape press member 56 and the tape roll 52, and adjust a force at which the double-sided adhesive tape 16B is pulled out. Specifically, three rollers 58a, 58b, and 58c are provided in a rotatable manner. Of these, the two rollers 58a and 58b are supported at fixed positions, whereas the remaining one roller 58c is supported so as to be capable of moving up and down. The roller 58c capable of moving up and down is positioned away from the other rollers 58a and 58b when the force at which the double-sided adhesive tape 16B is pulled out is weak, which increases slack in the double-sided adhesive tape 16B. Then, when the force at which the double-sided adhesive tape 16B is pulled out increases, the roller 58c capable of moving up and down moves toward the other rollers 58a and 58b. This reduces slack in the double-sided adhesive tape 16B, and using this part for affixing suppresses a situation in which the force at which the double-sided adhesive tape 16B is pulled out becomes too strong.

The base material 12B onto which the double-sided adhesive tape 16B has been affixed by the double-sided adhesive tape affixing section 50 is next transported to the length adjustment cutting section 60. In the length adjustment cutting section 60, the long base material 12B is adjusted to a predetermined dimension and then cut. Specifically, the length adjustment cutting section 60 has a length adjustment member 62 and a cutting member 64.

The length adjustment member 62 is a member that adjusts the transported base material 12B to a predetermined dimension. As described above, the pair of driving rollers 24 serving as the transport section 22 are incorporated into the length adjustment cutting section 60. The length adjustment member 62 is constituted of a rotary encoder or the like, for example, and measures the rotation of the driving rollers 24. The length adjustment member 62 can therefore measure the dimension of the base material 12B transported by the driving rollers 24. The cutting member 64 is constituted of a pair of blade members and a driving unit that drives the blade members, for example, and cuts the long base material 12B into the dimension adjusted to by the length adjustment member 62.

As described thus far, the wire harness outer member 10 is completed by adjusting the long base material 12B, in which the perforations 14 have been formed and to which the double-sided adhesive tape 16B has been applied, to the predetermined dimension and then cutting the base material 12B.

In the wire harness outer member 10, in the case where a position of a part of the member such as the center is to be specified, it is conceivable to provide a line 18 using a line marker or the like in the location to be specified. In this case, a line marker 70 may be incorporated into the manufacturing apparatus 20 for the wire harness outer member. In the example illustrated in FIGS. 2 and 3, the line marker 70 is disposed between the perforation processing section 30 and the double-sided adhesive tape affixing section 50.

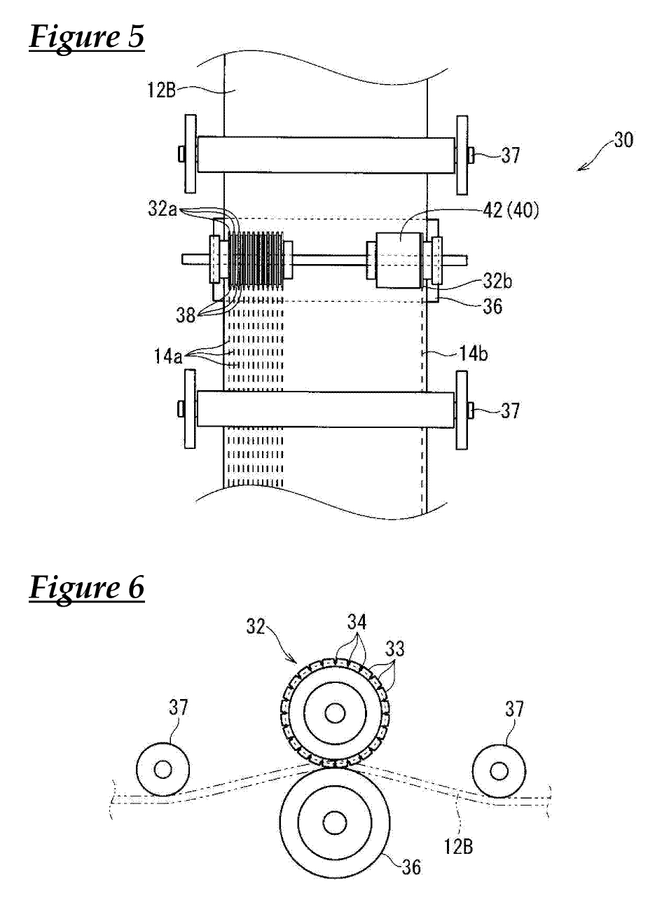

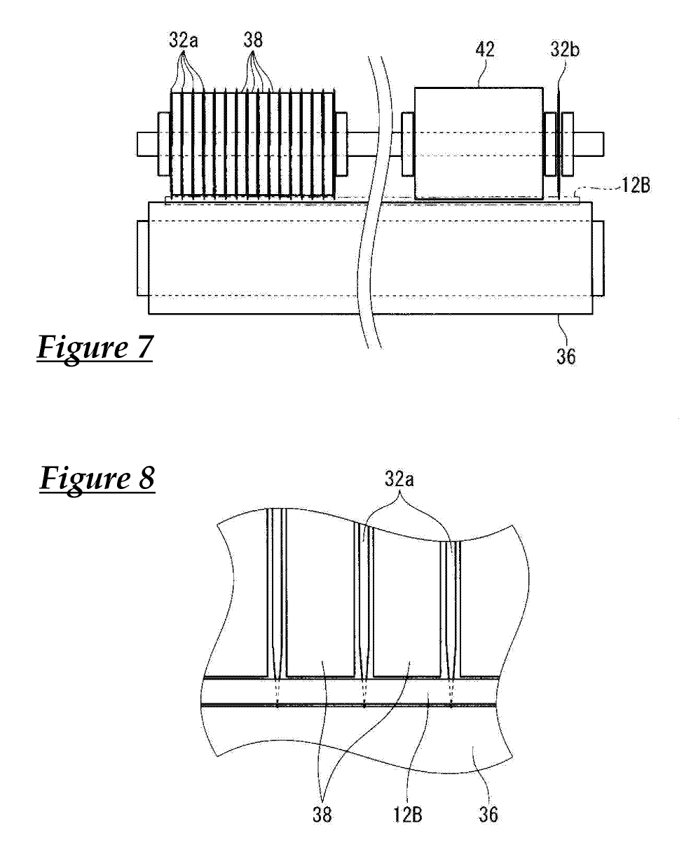

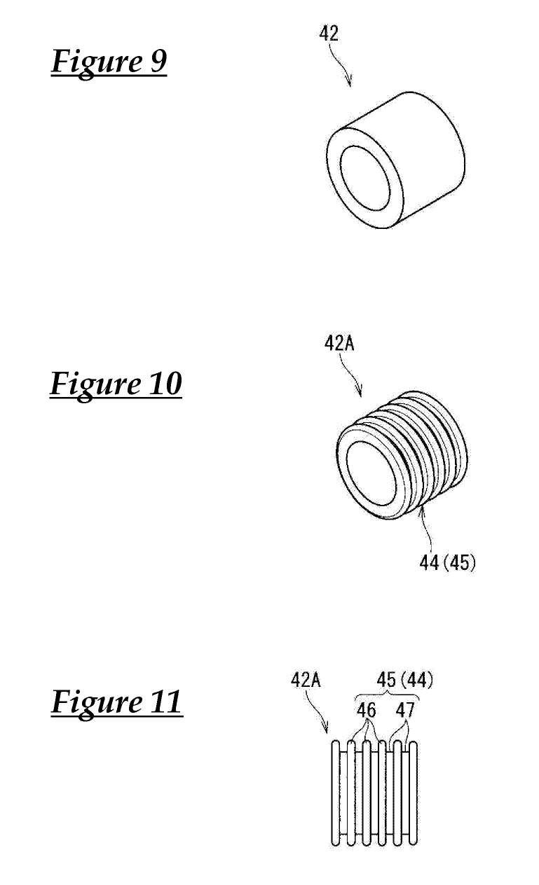

Next, the perforation processing section 30 and the tensile force correction member 40 will be described in detail with reference to FIGS. 5 to 9. FIG. 5 is a schematic plan view of the perforation processing section 30. FIG. 6 is a schematic side view of the perforation processing section 30. FIG. 7 is a schematic front view of the perforation processing section 30. FIG. 8 is a descriptive diagram illustrating a state where the perforating blades 32 make contact with the base material 12B. FIG. 9 is a perspective view of the tensile force correction member 40.

As described above, the perforation processing section 30 is a member that sequentially forms the perforations 14 in the transported base material 12B along the extension direction. The perforation processing section 30 includes the perforating blades 32 and the anvil 36. Here, the perforation processing section 30 further includes collar members 38.

The perforating blades 32 are provided capable of rotating around an axis following a direction intersecting with the extension direction of the base material 12. More of the perforating blades 32 are provided on one side than on the other side. Specifically, 12 of the perforating blades 32 are provided on the one side, and one of the perforating blades 32 is provided on the other side. In other words, perforating blades 32a on the one side form the perforations 14a, whereas a perforating blade 32b on the other side forms the perforations 14b. To form the perforations 14 in the base material 12B, each of the perforating blades 32 is formed such that teeth 33 protruding outward in a radial direction and recesses 34 recessed inward in the radial direction relative to the teeth 33 alternate continuously in the circumferential direction. Here, the length dimension of a single indentation 15 in the perforations 14 is determined by the dimensions of the teeth 33 in the circumferential direction of the perforating blades 32. Likewise, an interval between adjacent indentations 15 in the perforations 14 is determined by the dimensions of the recesses 34 in the circumferential direction of the perforating blades 32. Furthermore, the pitch of the perforations 14 is determined by the dimensions of the teeth 33 and the recesses 34 in the circumferential direction of the perforating blades 32. The aforementioned length dimension of the single indentation 15, the interval between adjacent indentations 15, the pitch of the perforations 14, and so on have values set as appropriate in consideration of the rigidity of the base material 12B, the diameter to be wrapped, and so on.

The anvil 36 is provided opposite the perforating blades 32. The anvil 36 is axially supported so as to be capable of rotating. The anvil 36 pinches the base material 12B against the perforating blades 32. Here, a single member that is longer in an axial direction is provided as the anvil 36, and the single anvil 36 is disposed opposite the perforating blades 32a on the one side and the perforating blade 32b on the other side. The material of which the anvil 36 is formed is not particularly limited, and preferably, the anvil 36 is formed from a material that is softer than the teeth 33, for example. The tips of the teeth 33 can bite into the anvil 36, and thus the indentations 15 of the perforations 14 can be formed in the base material 12B more reliably. It is conceivable to form the anvil 36 from a resin material such as urethane, for example.

It is furthermore preferable that the perforating blades 32 and the anvil 36 be provided such that a gap between the center axes thereof can be varied. This makes it possible to handle base materials 12B of different thicknesses. In the example illustrated in FIG. 5, the perforating blades 32a and the perforating blade 32b are supported by a single shaft member, but the perforating blades 32a and the perforating blade 32b may be supported by different shaft members. This makes it possible for the gap between the perforating blades 32a and the anvil 36, and the gap between the perforating blade 32b and the anvil 36, to be different.

Here, pressure rollers 37 are provided on the upstream and downstream sides of the perforating blades 32 and the anvil 36, with respect to the transport direction. The part of the base material 12B that makes contact with the anvil 36 is positioned higher than the parts that make contact with the pressure rollers 37. Accordingly, the anvil 36 and the base material 12B can make surface contact, improving the precision with which the perforating blades 32 form the perforations 14.

The collar members 38 are formed having a smaller diameter than the perforating blades 32. The collar members 38 are provided adjacent to the perforating blades 32. Here, the collar members 38 are disposed between adjacent perforating blades 32. The collar members 38 are formed in an annular shape, such as a disk shape, and are supported by the shaft member that supports the perforating blades 32. The collar members 38 make contact with the surface of the base material 12B in a state where the teeth 33 of the perforating blades 32 reach the interior of the base material 12B. Accordingly, the collar members 38 are pressed upon by the base material 12B so as to adjust the depth of the perforating blades 32 with respect to the base material 12B. As a result, in the case where there are different numbers of perforating blades 32 on the left and right sides of the base material 12B, a situation in which the perforating blades 32 bite too far into the anvil 36 can be suppressed. Additionally, the collar members 38 make contact with the side surfaces of the perforating blades 32 so as to support the perforating blades 32. A situation in which the perforating blades 32 tilt or rattle can therefore be suppressed.

The tensile force correction member 40 corrects a difference in the tensile force between the one side and the other side of the base material 12B. The tensile force correction member 40 is provided so as to be capable of pressurizing at least the side of the base material 12B having the smaller number of perforating blades 32. The tensile force correction member 40 may be formed using a metal, a resin, or an elastic material such as rubber as a material. Here, the tensile force correction member 40 is provided next to the perforating blade 32b on the other side of the base material 12B, and pinches the base material 12B against the anvil 36. The tensile force correction member 40 includes the roller 42, which rotates around an axis parallel to the rotation axis of the perforating blade 32b. Here, the roller 42 is supported by the shaft member that supports the perforating blade 32b.

The roller 42 is formed so that the surface thereof is uniform, with no concavities or convexities. The tensile force of the roller 42 is thought to be determined mainly by the material and size thereof. For example, when two rollers have the same size, but one roller is formed from a slippery material such as metal and the other is formed from a tacky material such as rubber, it is assumed that the latter roller will have a higher tensile force. Conversely, when two rollers are formed from the same material but one is smaller than the other, it is assumed that the larger roller will have a higher tensile force. There may be situations where the size of the roller 42 in the radial direction is greater than, less than, or equal to that of the teeth 33 of the perforating blades 32. Likewise, there may be situations where the size of the roller 42 in the axial direction is such that a region pressed by the roller 42 and the perforating blade 32b on the other side is greater than, less than, or equal to a region occupied by the perforating blades 32a on the one side.

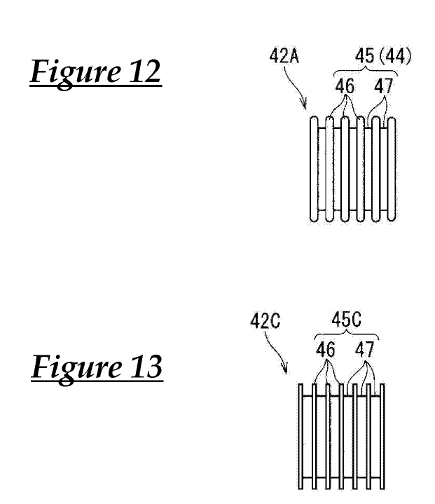

However, the shape of the roller 42 is not limited to those described above. Variations on the shape of the roller 42 will be described below with reference to FIGS. 10 to 13. FIG. 10 is a perspective view of a variation on the roller 42. FIG. 11 is a plan view of the variation on the roller 42. FIG. 12 is a plan view of another variation on the roller 42. FIG. 13 is a plan view of yet another variation on the roller 42.

In a roller 42A according to the variation illustrated in FIGS. 10 and 11, a non-planar part 44 is formed in the outer circumference of the roller 42A. Here, the non-planar part 44 includes axial direction non-planar parts 45 formed along the axial direction of the roller 42A. Accordingly, in the roller 42A, large annular portions 46 and small annular portions 47 are formed so as to alternate continuously along the axial direction. The roller 42A in which the axial direction non-planar parts 45 are formed in this manner is thought to catch the base material 12B better than the roller 42 in which the axial direction non-planar parts 45 are not formed.

The pitch of the axial direction non-planar parts 45 may be set as appropriate. For example, in a roller 42B according to another variation, illustrated in FIG. 12, the pitch of axial direction non-planar parts 45B is narrower than in the roller 42A. Additionally, in a roller 42C according to another variation, illustrated in FIG. 13, the pitch of axial direction non-planar parts 45C is narrower than in the roller 42B. The roller 42C is formed such that the pitch of the axial direction non-planar parts 45 is the same as the intervals between the perforating blades 32a arranged on the one side. Hereinafter, this roller 42C may be referred to as a “pseudo-blade roller”. The pseudo-blade roller on the other side and the perforating blade 32b are pressed at the same intervals in a region similar to that of the perforating blades 32a on the one side, and thus it is thought that adjusting the tensile force is comparatively easy.

The tensile force correction member 40 may be any member that reduces the difference in the tensile force on the left and right sides, and does not necessarily have to make the tensile force on the left and right sides equal.

### Manufacturing Method

Next, a method of manufacturing the wire harness outer member 10 using the above-described manufacturing apparatus 20 for the wire harness outer member will be described.

First, the base material 12B is transported along the extension direction (step (a)). Specifically, first, the leading end of the base material 12B is pulled out from the feed-out drum 26 along a transport path. The pulled-out leading end is set in the driving rollers 24. When the driving rollers 24 are driven in the state, the base material 12B is pulled out continuously from the feed-out drum 26 and transported in the extension direction.

Next, the perforations 14 are sequentially formed by the perforation processing section 30 in the transported base material 12B along the extension direction (step (b)). Here, the perforations 14 are formed by the perforating blades 32 rotating around an axis following the direction orthogonal to the extension direction, while the base material 12 is pinched between the perforating blades 32 and the anvil 36.

At this time, there are more perforating blades 32a on the one side of the base material 12B than the perforating blade 32b on the other side, and thus there is a different tensile force on the right and left sides of the base material 12B. Accordingly, here, the tensile force correction member 40 is pressed against the other side of the base material 12B to correct the difference in the tensile force between the one side and the other side of the base material 12B (step (c)). Here, the tensile force on the other side is corrected by pinching the base material 12B between the anvil 36 and the roller 42 provided on the side of the perforating blade 32b on the other side.

The base material 12B in which the perforations 14 have been formed by the perforation processing section 30 is transported downstream with the tensile force having been corrected. Downstream from the perforation processing section 30, first, the double-sided adhesive tape 16B is affixed to both outer edges of the base material 12B by the double-sided adhesive tape affixing section 50. Once the double-sided adhesive tape 16B has been affixed, the base material 12B is cut into predetermined dimensions by the length adjustment cutting section 60. The wire harness outer member 10 is completed as a result. At this time, the tensile force in the base material 12B is corrected by the perforation processing section 30, and thus a situation in which the base material 12B deviates from the transport path downstream from the perforation processing section 30 is suppressed. This reduces the likelihood of problems arising when affixing the double-sided adhesive tape 16B to the base material 12B in the double-sided adhesive tape affixing section 50. Furthermore, a situation in which adjustment errors arise in the length adjustment cutting section 60 or the base material 12B becomes crooked during cutting can be suppressed.

According to the manufacturing method and the manufacturing apparatus 20 for the wire harness outer member described above, a difference in the tensile force on the left and right sides of the base material 12B is corrected by pressing the tensile force correction member 40 provided on the other side that has fewer perforating blades 32 against the base material 12B. Thus when manufacturing the wire harness outer member 10 in which different numbers of perforations 14 are provided on the left and right sides of the base material 12B, the force at which the base material 12B is transported can be balanced between the left and right sides of the base material 12B to the greatest extent possible. Accordingly, a situation in which the base material 12B deviates from the transport path can be suppressed, and thus it is more difficult for problems caused by the base material 12B deviating from the transport path when being processed on the downstream side to arise.

Additionally, the tensile force correction member 40 is provided alongside the perforating blade 32b on the other side, and pinches the base material 12B against the anvil 36. Accordingly, the tensile force can be corrected at the position of the perforating blades 32 with respect to the transport direction of the base material 12B.

Additionally, the tensile force correction member 40 includes the roller 42 that rotates around an axis parallel to the rotation axis of the perforating blade 32b, and thus rotates in the same manner as the perforating blade 32b. Accordingly, it is more difficult for excess force to be applied than in the case where the tensile force correction member 40 does not rotate.

Additionally, the non-planar part 44 is formed in the outer circumference of the roller 42, and thus it is easier to catch the base material 12B than in the case where the non-planar part 44 is not provided. In particular, the non-planar part 44 includes the axial direction non-planar parts 45 formed along the axial direction of the roller 42, and thus it is easier to catch the base material 12B than in the case where the non-planar part 44 is not provided in the axial direction.

Additionally, the roller 42 includes the pseudo-blade roller in which the pitch of the axial direction non-planar parts 45 is formed to be the same as the intervals of the perforating blades 32a arranged on the one side. The pseudo-blade roller thus catches the base material 12B along a direction intersecting with the extension direction at the same intervals as the perforating blades 32a, which makes it more difficult for the base material 12B to twist or the like.

Additionally, the depth of the perforating blades 32a is adjusted by the collar members 38 formed having smaller diameters than the perforating blades 32a and provided adjacent to the perforating blades 32a, and thus a situation in which the perforating blades 32a bite into the anvil 36 excessively can be suppressed.

Note that when there are different numbers of the perforating blades 32 on the left and right sides of the base material 12B, different pressures will act on a single one of the perforating blades 32 on the left and right sides of the base material 12B. Specifically, a greater pressure acts on the single perforating blade 32b, which is on the less numerous side, than on the perforating blades 32a, which are on the more numerous side. Thus it is easier for the perforating blade 32b to bite into the anvil 36 than the perforating blades 32a. If the perforating blades 32 bite into the anvil 36 excessively, the replacement cycle of the anvil 36 will shorten, leading to a corresponding rise in costs. However, the roller 42 is provided to the side of the perforating blade 32b here, which makes it possible to reduce the pressure acting on the perforating blade 32b and suppress a situation in which the perforating blade 32b bites into the anvil 36 excessively.

### Variations

The above embodiment describes the tensile force correction member 40 as being provided alongside the perforating blade 32b on the other side and pinching the base material 12B against the anvil 36. However, this is not an absolutely necessary configuration. For example, the tensile force correction member 40 may be provided in a position distanced from the perforating blade 32b in the transport direction.

Additionally, the above embodiment describes the tensile force correction member 40 as including the roller 42, which rotates around an axis parallel to the rotation axis of the perforating blade 32b. However, this is not an absolutely necessary configuration. For example, the tensile force correction member may be configured such that a non-rotating member is pressed against the base material 12B.

Additionally, the embodiment describes the non-planar part 44 as including the axial direction non-planar parts 45 formed along the axial direction of the roller 42. However, this is not an absolutely necessary configuration. The non-planar part 44 may include circumferential direction non-planar parts formed along the circumferential direction. In this case, the roller including the circumferential direction non-planar parts has a similar shape as the perforating blades 32, and thus catches the base material 12B more easily than in the case where the circumferential direction non-planar parts are not provided. However, unlike the teeth 33 of the perforating blades 32, the protruding parts of the circumferential direction non-planar parts are formed so as not to cut the base material 12B. Furthermore, forming the circumferential direction non-planar parts so that the pitch thereof is the same as the pitch of the non-planarities of the perforating blades 32 in the circumferential direction is also conceivable. In this case, the roller in which the circumferential direction non-planar parts catches the base material 12B at the same pitch as the teeth 33 of the perforating blades 32 along the extension direction of the base material 12B, and thus it is difficult for the base material 12B to twist or the like.

Additionally, the above embodiment describes the double-sided adhesive tape affixing section 50 as being provided downstream from the perforation processing section 30. However, this is not an absolutely necessary configuration, and the perforation processing section 30 may be provided downstream from the double-sided adhesive tape affixing section 50. Here, in the case where the region where the double-sided adhesive tape 16B is affixed and the region where the perforations 14 are provided overlap, the perforations 14 are formed in the double-sided adhesive tape 16B as well.

The configurations described in the above embodiment and variations can be combined as appropriate as long as the configurations do not conflict with each other.

While the invention has been described in detail above, the foregoing descriptions are in all ways exemplary, and the invention is not intended to be limited thereto. It is to be understood that countless variations not described here can be conceived of without departing from the scope of the invention.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10 Wire harness outer member

12 Base material

14 Perforation

16 Double-sided adhesive tape

20 Manufacturing apparatus for wire harness outer member

22 Transport section

24 Driving roller

26 Feed-out drum

30 Perforation processing section

32 Perforating blade

36 Anvil

38 Collar member

40 Tensile force correction member

42 Roller

44 Non-planar part

45 Axial direction non-planar part

50 Double-sided adhesive tape affixing section

60 Length adjustment cutting section

W Wire

What is claimed is:

1. A method of manufacturing a wire harness outer member in which many perforations are provided on one side of a base material relative to the center of the base material than on the other side, the method comprising the steps of:
(a) transporting the base material in an extension direction;
(b) sequentially forming perforations in the transported base material along the extension direction by rotating perforating blades around an axis following a direction intersecting with the extension direction while pinching the base material between the perforating blades and an anvil provided opposite the perforating blades, more of the perforating blades being provided on the one side than on the other side; and
(c) correcting a difference in tensile force between the one side and the other side of the base material by pressing a tensile force correction member against the other side of the base material.

2. The method of manufacturing a wire harness outer member according to claim 1,
wherein the tensile force correction member is provided alongside the perforating blades on the other side, and pinches the base material against the anvil.

3. The method of manufacturing a wire harness outer member according to claim 2,
wherein the tensile force correction member includes a roller that rotates around an axis parallel to a rotation axis of the perforating blades.

4. The method of manufacturing a wire harness outer member according to claim 3,
wherein a non-planar part is formed in an outer circumference of the roller.

5. The method of manufacturing a wire harness outer member according to claim 4,
wherein the non-planar part includes an axial direction non-planar part formed along an axial direction of the roller.

6. The method of manufacturing a wire harness outer member according to claim 5,
wherein the roller includes a pseudo-blade roller formed so that a pitch of the axial direction non-planar part is the same as intervals between the perforating blades arranged on the one side.

7. The method of manufacturing a wire harness outer member according to claim 1,
wherein a depth of the perforating blades relative to the base material is adjusted by pressing a collar member formed having a smaller diameter than the perforating blades and provided adjacent to the perforating blades against the base material.

8. A manufacturing apparatus for a wire harness outer member in which many perforations are provided on one side of a base material relative to the center of the base material than on the other side, the apparatus comprising:
a transport section that transports the base material in an extension direction;
a perforation processing section, including perforating blades capable of rotating around an axis following a direction intersecting with the extension direction, more of the perforating blades being provided on the one side than on the other side, and an anvil, provided opposite the perforating blades, that pinches the base material against the perforating blades, the perforation processing section sequentially forming perforations in the transported base material along the extension direction; and
a tensile force correction member, provided capable of pressing on the other side, that corrects a difference in tensile force between the one side and the other side of the base material.
